(19) United States
(12) Patent Application Publication
(10) Pub. No.: US 2026/0138491 A1
(43) Pub. Date: May 21, 2026

(54) BATTERY SWAPPING STATION

(71) Applicant: Clean Electric Private Limited, Bhopal (IN)

(72) Inventors: Abhinav ROY, Begusarai (IN); Ankit JOSHI, Nimbahera (IN); Akash GUPTA, Bhopal (IN); Hirdesh VANSHKAR, Bhopal (IN)

(21) Appl. No.: 19/119,091

(22) PCT Filed: Aug. 31, 2023
(86) PCT No.: PCT/IN2023/050824

§ 371 Date: Apr. 7, 2025

(30) Foreign Application Priority Data
Oct. 7, 2022 (IN) 202221057490

(51) Int. Cl. B60L 53/80; B60L 53/302; B60L 58/18; B60L 58/26; B60L 58/27

(52) U.S. Cl. CPC B60L 53/80; B60L 53/302; B60L 58/18; B60L 58/26; B60L 58/27; B60L 2240/545

(57) ABSTRACT

The present invention discloses a battery swapping station (100). The battery swapping station (100) includes a plurality of battery swapping slots (102), a plurality of batteries (104), and a base plate assembly (106). The plurality of batteries is detachably inserted into the plurality of battery swapping slots (102). The disclosed battery swapping station (100) enables efficient temperature control of the plurality of batteries (104), and enables faster charging through temperature modulation. If one base plate of a plurality of base plates (108) is movable in a downward position, an accommodating space is created for the at least one battery of the plurality of batteries (104) to slide over the accommodating space without interference. If one battery of the plurality of batteries (104) is inserted inside the accommodating space, the one base plate of the plurality of base plates (108) is configured to be movable in an upward position.

### FIELD OF THE DISCLOSURE

This invention generally relates to a field of electric vehicle batteries and thermal management techniques implemented for battery packs of the electric vehicle, and more specifically relates to a battery swapping station having a casing used as a heat transfer surface, to dissipate heat of the battery or heat up the battery, in order to maintain desired temperature of a battery pack in the battery swapping station.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Battery swapping is an alternative that involves exchanging discharged batteries for charged ones. The battery swapping de-links the vehicle and fuel, and thereby leads to a reduction in upfront cost of the vehicles. The concept of battery swapping is popularly used for smaller vehicles, like two and three-wheeler vehicles, which have smaller batteries that are easier to swap compared to other automotive segments, where the same feature can be implemented mechanically. Considering constraint of space in urban areas for setting up battery swapping stations at a large-scale, the honourable finance minister in her budget speech of 2022-23 has announced that the Union Government will introduce a Battery Swapping Policy and interoperability standards to improve efficiency in electric vehicle ecosystem. There have been many battery swapping stations developed in recent past which are configured to facilitate dissipation of the heat of the battery pack, while charging or discharging the battery in the battery swapping station.

Considering current scenario of battery swapping station designs, there are different types of the battery swapping stations designs which are available in market. One battery swapping design is basically a pod-like automated unit that houses six batteries and keeps them charged and ready for use. This automated unit is either attached to a store, or may be independently located, and are open anytime for a rider. Every swap takes no longer than 1-2 minutes, so that swapping never makes a dent in one's schedule. Another battery swapping design involves use of an electric vehicle battery thermal management device which involves the thermal management of the battery of electric accumulator cells assembled within a rigid casing. A thermal storage means is incorporated into the battery and comprises of a chamber containing a phase-change material, and having a volume for exchange of heat with the accumulator cells which is delimited by a part of the rigid casing. Melting of the phase-change material is being able to store heat, and solidification of the phase-change material is being able to release the heat previously stored. The chamber is equipped at its distal end with an expansion vessel able to absorb the expansions of the phase-change material as it changes phase.

The present battery swapping station designs aforementioned above, are available in market and employed for two and three-wheeler vehicles are air cooled or sometimes without any cooling. This results in significant increase in battery temperature during charging in the swapping station. The batteries in this present battery swapping station designs have a cooling technology that takes the heat from the cell to the casing of the battery pack with high efficiency. In the present battery swapping station designs, the battery pack maintains a homogenous temperature with liquid cooling, and the heat from the cells is transferred to the casing without much temperature differences. But a major drawback of using the present battery swapping station designs is that the cooling technique utilized by the batteries is unable to extract heat from the battery casing and maintain the temperature of the battery in the battery swapping station. This results in accelerated degradation of battery life during fast charging. In addition to this, one another drawback of the present battery swapping station designs is that the battery pack in these swapping stations rejects heat via natural convection or forced convection, which is one of the most inefficient methods of thermal management of the battery. Moreover, the air-cooling technique used in the present battery swapping station designs to cool the battery packs is inefficient and incapable of modulating the temperature of the battery as per charging algorithms.

Hence, in view of the above, it is desired to address above mentioned disadvantages or other shortcomings by providing an efficient, thoroughly designed, and modulated battery swapping station configured to increase the battery life of the two or three-wheeler battery packs, by extracting heat from the battery casing, to maintain the temperature of the battery in the battery swapping station as well as heating and cooling the battery at different points in the charging process, thereby saving charging time and efforts and eventually money or at least provide a useful alternative.

### OBJECTIVES OF THE INVENTION

It is an objective of the invention to provide a battery swapping station configured to increase battery life of the two or three-wheeler battery packs.

It is an objective of the invention to provide the battery swapping station which comprises of a casing as a heat transfer surface to dissipate heat of the battery or heat up the battery.

It is an objective of the invention to provide the battery swapping station which is configured to maintain a desired temperature of the battery pack in the swapping station.

It is an objective of the invention to provide the battery swapping station which comprises a movable base plate to be used as an effective solution for controlling thermal characteristics of battery packs in the battery swapping station.

It is an objective of the invention to provide the battery swapping station which is configured to extract heat from the battery casing, to maintain the temperature of the battery pack in the battery swapping station.

It is an objective of the invention to provide the battery swapping station which is configured for modulating the temperature of the battery pack as per charging algorithms.

It is an objective of the invention to provide the battery swapping station which is configured to modulate charging current and the temperature of the battery for a better life with fast charging.

It is an objective of the invention to provide the battery swapping station which is configured to both heat and cool the battery at different points in charging process.

It is an objective of the invention to provide the battery swapping station which comprises of the movable base plate that is configured to maintain the temperature of the battery pack, as required for charging or storing the battery.

It is an objective of the invention to provide the battery swapping station which is configured to allow more dispensable batteries to be charged, thereby charging of batteries of more vehicles from a same area footprint.

It is an objective of the invention to provide the battery swapping station which has simple structure.

It is an objective of the invention to provide the battery swapping station which is cost effective.

### SUMMARY

According to a main aspect, the present embodiments disclose a battery swapping station. The battery swapping station comprises a plurality of battery swapping slots, a plurality of batteries, and a base plate assembly. The plurality of batteries is configured to be detachably inserted into the plurality of battery swapping slots. The base plate assembly is configured to be housed inside the plurality of battery swapping slots and connected with the plurality of batteries. The base plate assembly comprises a plurality of base plates, and a plurality of thermal pads. Each base plate of the plurality of base plate have a heat transfer surface. Each of the plurality of base plates is configured to extract heat from a battery casing and deliver heat to at least one battery of the plurality of batteries. The plurality of thermal pads with each thermal pad is configured to cover the heat transfer surface of each base plate of the plurality of base plates. The base plate assembly is configured to be mechanically mounted on a plurality of guide rails. If at least one base plate of the plurality of base plates is movable in a downward position, an accommodating space is created for the at least one battery of the plurality of batteries to slide over the accommodating space without interference. If the at least one battery of the plurality of batteries is inserted inside the accommodating space, the at least one base plate of the plurality of base plates is configured to be movable in an upward position, until a certain amount of force between the at least one base plate and the at least one battery is achieved.

The plurality of battery swapping slots, the plurality of batteries, the base plate assembly, the plurality of base plates, the plurality of thermal pads, and the plurality of guide rails are integrated as a single unit to form the battery swapping station.

According to another aspect, the present embodiments disclose a battery swapping station. The battery swapping station comprises the plurality of battery swapping slots, the plurality of batteries, a sensor and a swapping controller. The plurality of batteries is configured to be detachably inserted into the plurality of battery swapping slots. The sensor is configured to be housed within at least one battery swapping slot to detect the plurality of batteries. The swapping controller is communicably coupled with the plurality of battery swapping slots, the plurality of batteries, and the sensor and configured to enable the plurality of base plates to engage with a battery pack. The swapping controller is further configured to switch position of the three-way valve based on engagement of the plurality of base plates with the battery pack. The swapping controller is further configured to activate a cooling loop or a heating loop, based on the switched position of the three-way valve. If at least one battery is detected in the at least one battery swapping slot, at least one motor of the plurality of motors is configured to move the base plate assembly towards the battery pack, and activate the cooling loop or the heating loop based on required battery temperature. The at least one battery is configured to be preheated during charging mode by turning on the heating loop, upon plugging the at least one battery into the at least one battery swapping slot. The at least one battery is further configured to be cooled based on a thermal profile selected to run for the at least one battery, or if the at least one battery is already too hot prior to insertion of the at least one battery into the at least one battery swapping slot.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an isometric view of a battery swapping station with at least one battery swap slot, according to an embodiment of the present invention;

FIG. 2 illustrates an isometric view of the battery swapping station, according to another embodiment of the present invention;

FIG. 3 illustrates a rear view of the battery swapping station, according to one embodiment of the present invention;

FIG. 4 illustrates a front view of the battery swapping station, according to another embodiment of the present invention;

FIG. 5 illustrates a schematic view of the battery swapping station having a base plate assembly, according to one embodiment of the present invention;

FIG. 6A illustrates a schematic view of the battery swapping station having at least one base plate in a relaxed position, according to one exemplary embodiment of the present invention;

FIG. 6B illustrates a schematic view of the battery swapping station having the at least one base plate in an engaged position, according to another exemplary embodiment of the present invention;

FIG. 7 illustrates an isometric view of a battery swapping station having a heating unit and a cooling unit, according to an embodiment of the present invention;

FIG. 8 illustrates a schematic view of a cooling loop formed in the battery swapping station, according to one embodiment of the present invention; and

FIG. 9 illustrates a schematic view of a heating loop formed in the battery swapping station, according to another embodiment of the present invention.

### DETAILED DESCRIPTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described, and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

The present invention discloses a battery swapping station. The battery swapping station of the present invention is configured to be used for portable or swappable two and three-wheeler battery packs, in which casing is used as a heat transfer surface. The same casing is used to dissipate heat of the battery or heat up the battery. This dissipation of heat of the battery is configured to maintain desired temperature of the battery pack in the battery swapping station.

The battery swapping station is configured to extract heat from the battery casing, to maintain the temperature of the battery pack in the battery swapping station. The battery swapping station is further configured to modulate the temperature of the battery pack as per charging algorithms. The battery swapping station is further configured to modulate charging current and the temperature of the battery for a better life with fast charging.

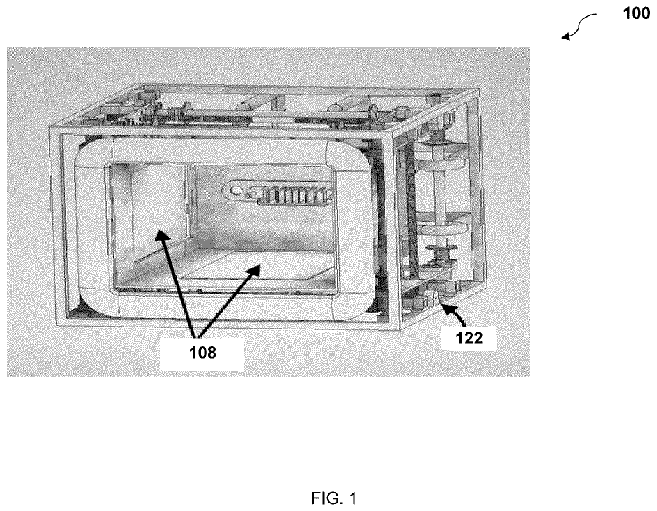

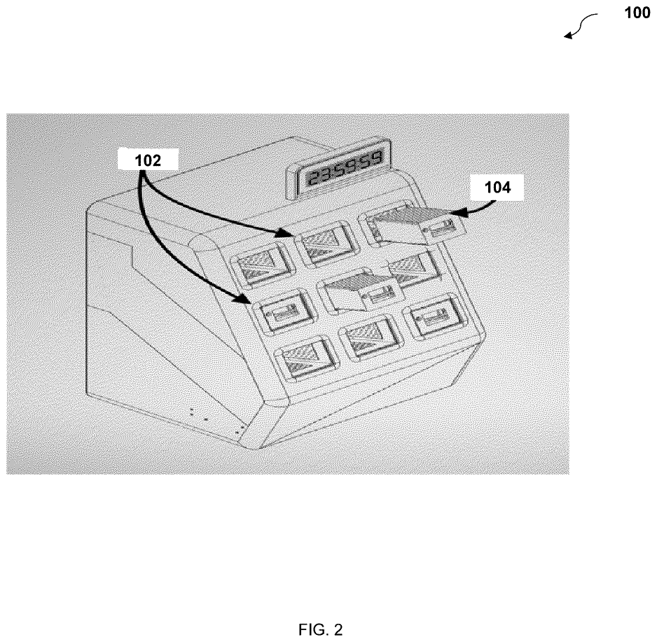

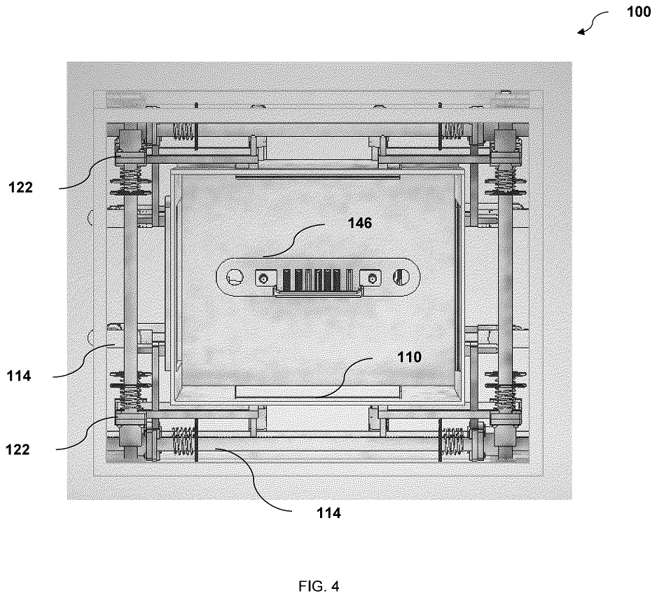

The battery swapping station of the present invention will now be explained with reference to the FIGS. 1-9. FIG. 1 illustrates an isometric view of a battery swapping station (100) with at least one battery swap slot, according to an embodiment of the present invention. FIG. 1 will be explained in conjunction with FIGS. 2-9. The battery swapping station (100) shown in FIG. 1 comprises a plurality of base plates (108) and a plurality of electric motors (122). Each of the plurality of base plates (108) have a heat transfer surface (shown in FIG. 4). Each of the plurality of base plates (108) is configured to extract heat from a battery casing and heat at least one battery of the plurality of batteries (shown in FIG. 2). Each of the plurality of base plates (108) is basically a heat transfer plate that is configured to move in order to come in contact with at least one battery of the battery swapping station (100).

In one embodiment, each of the plurality of base plates (108) is further configured to be in contact with the at least one battery, but only when the at least one battery is inserted inside at least one battery swapping slot of the battery swapping station (100).

In another embodiment, each of the plurality of base plates (108) is configured to loosen up or tighten up its contact with the at least one battery.

In yet another embodiment, each of the plurality of base plates (108) is configured to provide fluid flow channels, the fluid flow channels formed within each of the plurality of base plates (108).

In yet another embodiment, the plurality of base plates (108) may be, but not restricted to, be composed of aluminium material, stainless-steel material, copper material, or any other highly thermal conductive material.

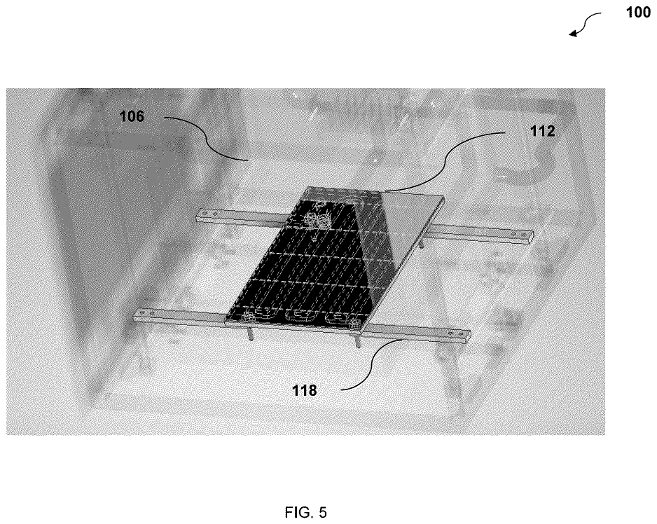

The battery swapping station (100) comprises of the plurality of electric motors (122) configured to control position of the plurality of base plates (108). The plurality of electric motors (122) is further configured to move a base plate assembly (shown in FIG. 5) towards a battery pack or at least one battery of the plurality of batteries.

In one embodiment, the plurality of electric motors (122) may be, but not restricted to, a Direct Current (DC) motor, an Alternating Current (AC) motor, or any high-power motor.

FIG. 2 illustrates an isometric view of the battery swapping station (100), according to another embodiment of the present invention. The battery swapping station (100) comprises of plurality of battery swapping slots (102) and a plurality of batteries (104). The plurality of battery swapping slots (102) is configured to house a base plate assembly (shown in FIG. 5). The plurality of battery swapping slots (102) is further configured to provide a space for each of the plurality of batteries (104) to get inserted.

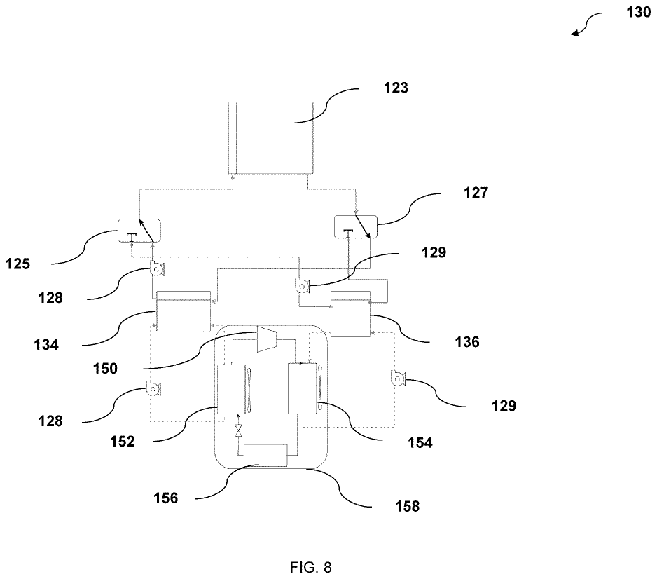

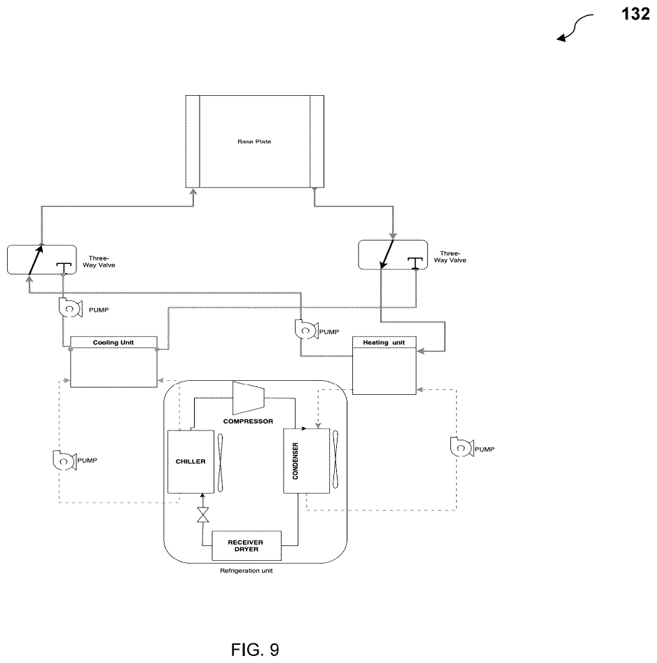

In one embodiment, the plurality of battery swapping slots (102) is configured to connect a cooling loop (shown in FIG. 8) and a heating loop (shown in FIG. 9) in a parallel configuration.

In another embodiment, the plurality of battery swapping slots (102) is configured to enable the plurality of batteries (104) to get directly charged or swapped.

The plurality of batteries (104) is configured to be detachably inserted into the plurality of battery swapping slots (102). The plurality of batteries (104) is configured to be connected with the base plate assembly.

In one embodiment, if at least one battery is detected in the at least one battery swapping slot, at least one motor of the plurality of motors (122) is configured to move the base plate assembly towards the battery pack.

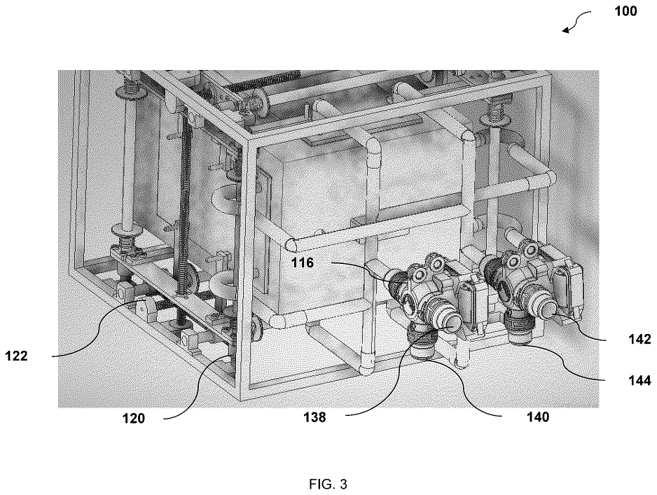

FIG. 3 illustrates a rear view of the battery swapping station (100), according to one embodiment of the present invention. The battery swapping station (100) comprises a three-way valve (116), a plurality of linear bearings (120), the plurality of electric motors (122), a cooling fluid inlet (138), a heating fluid inlet (140), a cooling fluid outlet (142), and a heating fluid outlet (144). The three-way valve (116) is configured to connect each of the plurality of base plates (108) with the cooling loop and the heating loop. The three-way valve (116) is further configured to configured to be open or close to either of the cooling loop and the heating loop. The three-way valve (116) is further configured to switch its position based on engagement of the plurality of base plates (108) with the battery pack.

In one embodiment, a change in position of the three-way valve (116) is configured to activate the cooling loop.

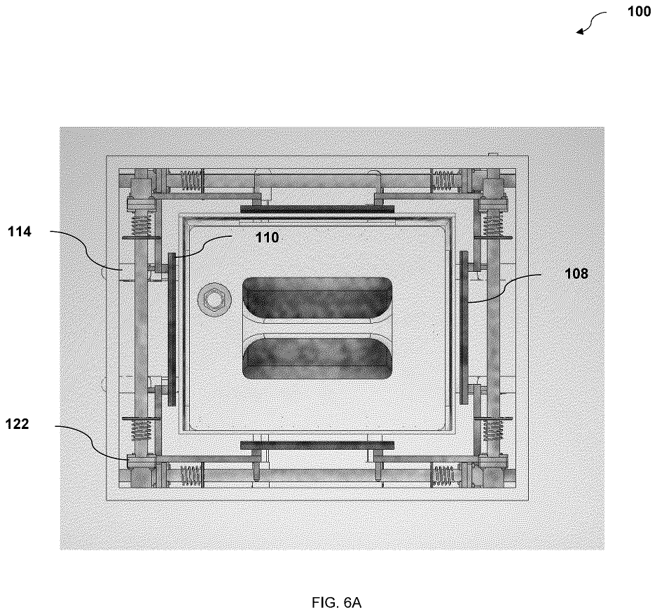

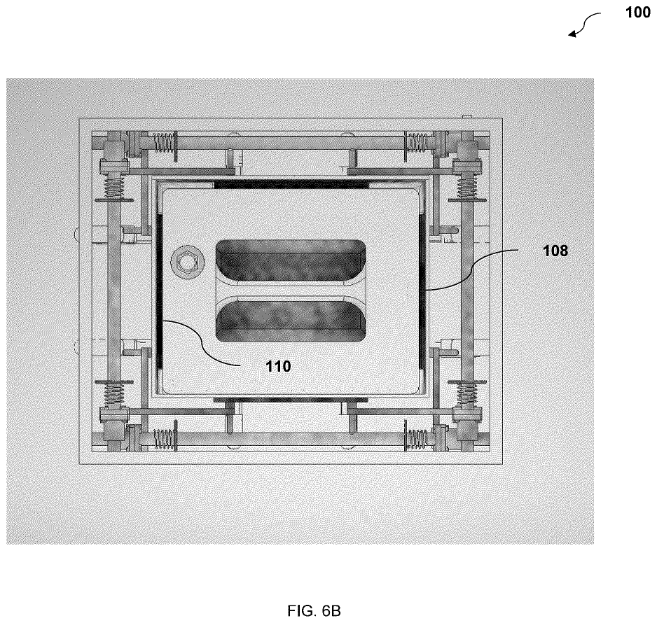

The plurality of linear bearings (120) is configured to be positioned adjacent to the plurality of electric motors (122). The plurality of linear bearings (120) is further configured to provide passage for a plurality of rigid bars (shown in FIG. 5) to move over the plurality of guide rails (shown in FIG. 6A).

In one embodiment, the plurality of linear bearings (120), may be, but not restricted to, be of a spherical shape.

The battery swapping station (100) further comprises the cooling fluid inlet (138), the heating fluid inlet (140), the cooling fluid outlet (142), and the heating fluid outlet (144). The cooling fluid inlet (138) is configured to provide a passage for a cooling fluid to enter within a portion of the plurality of base plates (108). The heating fluid inlet (140) is configured to provide a passage for a heating fluid to enter within the portion of the plurality of base plates (106). The cooling fluid outlet (142) is configured to provide a passage for the cooling fluid to move out of the portion of the plurality of base plates (106). The heating fluid outlet (144) is configured to provide a passage for the heating fluid to move out of the portion of the plurality of base plates (106).

FIG. 4 illustrates a front view of the battery swapping station (100), according to another embodiment of the present invention. The battery swapping station (100) comprises of a heat transfer surface (110), a plurality of guide rails (114), the plurality of electric motors (122), and an electrical connector (146). The heat transfer surface (110) is configured to be positioned within each of the plurality of base plates (108). The heat transfer surface (110) is configured to be covered by each of a plurality of thermal pads (shown in FIG. 5). The plurality of guide rails (114) is configured to be positioned adjacent to the plurality of electric motors (122). The plurality of guide rails (114) may be configured to be connected with the plurality of base plates (108). The electrical connector (146) is configured to be positioned within the battery swapping station (100), in a manner that the electrical connector (146) is surrounded by the plurality of base plates (108), from all four sides of an inner periphery of the battery swapping station (100).

FIG. 5 illustrates a schematic view of the battery swapping station (100) having the base plate assembly, according to one embodiment of the present invention. The battery swapping station (100) of FIG. 5 comprises a base plate assembly (106), a plurality of thermal pads (112), and a plurality of rigid bars (118). The base plate assembly (106) is configured to be housed inside the plurality of battery swapping slots (102) and connected with the plurality of batteries (104). The base plate assembly (106) is further configured to be mechanically mounted on the plurality of guide rails (114).

In one embodiment, the base plate assembly (106) is further configured to move towards the battery pack due to power provided by at least one electric motor of the plurality of electric motors (122).

The plurality of thermal pads (112) is configured to be positioned adjacent to the plurality of rigid bars (118). The plurality of thermal pads (112) is further configured to cover the heat transfer surface (110) of each base plate of the plurality of base plates (108). The plurality of thermal pads (112) is further configured to provide thermal conductivity to each of the plurality of base plates (108).

In one embodiment, the plurality of thermal pads (112) may be, but not restricted to, made of a silicon-based material, or any highly thermal conductive material.

The plurality of rigid bars (118) is configured to detachably mount the plurality of base plates (108), through a spring. The plurality of rigid bars (118) is further configured to be movable over the plurality of guide rails (114), through a plurality of linear bearings (120).

In one embodiment, the plurality of rigid bars (118) may be, but not restricted to, be made of a stainless-steel material, an aluminium material, or any high tensile strength material.

FIG. 6A illustrates a schematic view of the battery swapping station (100) having at least one base plate in a relaxed position, according to one exemplary embodiment of the present invention. As shown in FIG. 6A, the at least one base plate may be configured to be positioned on top portion of the battery swapping station (100), and may be considered as a top base plate. The plurality of base plates (108) is positioned at all four corners of the battery swapping station (100), that is, the at least one base plate may be configured to be pointing towards any direction. The at least one base plate is a heat transfer plate that moves in order to come into contact with at least one swappable battery. The at least one base plate may be configured to be in contact in with a battery module, only when the at least one battery is inserted inside the at least one battery swapping slot of the battery swapping station (100).

In one embodiment, the battery swapping station (100) comprises of a receptacle (shown in light green colour) for receiving the plurality of batteries (104). The receptacle is constructed in a manner that enables the at least one base plate to be movable, to loosen up or tighten up its contact with the at least one battery.

In another embodiment, when each of the plurality of base plates (108) are in a relaxed position, that is, when the at least one base plate moves downwards, the at least one base plate is configured to provide an extra space for the at least one battery to slide in without interference. The at least one base plate will loosen up its contact with the battery.

In yet another embodiment, when the at least one battery of the plurality of batteries (104) is inserted inside the accommodating space, the at least one base plate of the plurality of base plates (108) is configured to be movable in an upward position, until a certain amount of force between the at least one base plate and the at least one battery is achieved, to provide a good thermal contact between the at least one base plate and the at least one battery.

FIG. 6B illustrates a schematic view of the battery swapping station (100) having the at least one base plate in an engaged position, according to another exemplary embodiment of the present invention. When the at least one base plate is moving downwards, it becomes easy for the at least one battery to get inserted inside the battery swapping station (100). If the at least one base plate is moving upwards, the at least one battery gets inserted inside the battery swapping station (100). The at least one battery or the plurality of batteries (104) is configured to be clamped between top surface of the receptacle and the at least one base plate. With reference to the FIG. 6B, the at least one base plate or the plurality of base plates (108) is configured to compress the at least one battery or the plurality of batteries (104).

In an embodiment, a top base plate is shown which is positioned at top of the receptacle. The top plate need not require movement and a bottom plate as shown may be configured to create a thermal contact between the top base plate and the at least one battery, as the bottom plate is configured to slightly lift the at least one battery in an upward direction. The condition of maintaining the thermal contact to be established only comes into play when the at least one battery has been already inserted.

In one embodiment, the at least one base plate comprises an extra locking system which is configured to provide locking via high clamping force leading to a high static friction limit, to prevent extraction of the at least one battery from the at least one battery swapping slot without permission, when the plurality of base plates (108) is in the engaged position.

A similar arrangement of the at least one battery and the at least one base plate as shown in the figure may be replicated in a transverse direction, i.e., horizontal direction. In case, even if more performance is required out of this thermal contact, the vertical arrangement of the at least one battery and the at least one base plate may be replicated in a horizontal direction to make contact area doubled. The contact area is the area between the battery casing and the plurality of base plates (108). The battery casing is a protective cover for the at least one battery.

The battery casing comprises of two end plates which are being reinforced with aluminium to provide the protective cover for easy insertion of the battery. The battery casing is further configured to protect the at least one battery from any kind of damage caused due to environmental conditions. Aluminium is selected for production of the battery casing as aluminium has a good thermal conductivity. Moreover, aluminium is essentially lightweight and strong and having high tensile strength. For instance, “A6061T6” is an aluminium alloy which provides high strength and a good mix of thermal properties. Since the present invention discloses the design of the battery swapping station (100), the selection of aluminium as the material is a best choice for achieving design configuration of the battery swapping station (100).

In one embodiment, the battery casing comprises of a dielectric coolant present within the battery casing. The dielectric coolant is further configured to get circulated inside the at least one battery or multiple batteries of the battery swapping station (100). The circulation essentially brings out the heat from the cells to the battery casing. This is called as convection phenomenon. From the dielectric coolant, the heat comes out to the battery casing. From the battery casing, the heat comes out with a thermal interface material. The heat then reaches the plurality of base plates (108) or cooling plate from the thermal interface material. At last, the heat then reaches the cooling loop of the battery swapping station (100) from the plurality of base plates (108).

In another embodiment, the coolant inside the battery is always the dielectric coolant, and the coolant inside the battery casing or the cooling plate is the dielectric coolant or a water glycol as a non-dielectric coolant or any other non-dielectric coolant.

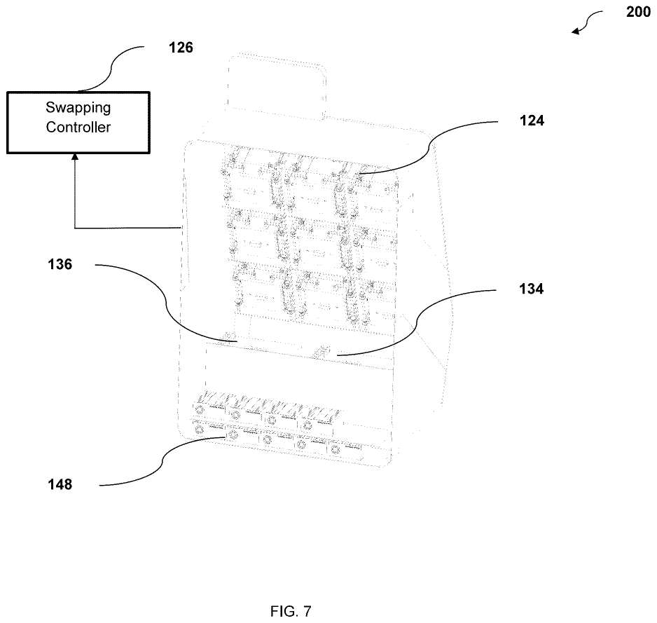

FIG. 7 illustrates an isometric view of a battery swapping station (200) having a heating unit and a cooling unit, according to an embodiment of the present invention. The battery swapping station (200) as shown in FIG. 7 comprises of a sensor (124), a swapping controller (126), a cooling reservoir (134), a heating reservoir (136), and a charging unit (148). The sensor is configured to be housed within the at least one battery swapping slot. The sensor (124) is further configured to detect the plurality of batteries (104). The swapping controller (126) is communicably coupled with the plurality of battery swapping slots (102), the plurality of batteries (104), and the sensor (124) and configured to enable the plurality of base plates (108) to engage with the battery pack. The swapping controller (126) is further configured to switch position of the three-way valve (116) based on engagement of the plurality of base plates (108) with the battery pack. The swapping controller (126) is further configured to activate a cooling loop (shown in FIGS. 8 and 9) or the heating loop (shown in FIGS. 8 and 9), based on the switched position of the three-way valve (116).

In one embodiment, if at least one battery detects the at least one battery swapping slot, at least one motor of the plurality of motors (122) is configured to move the base plate assembly (106) towards the battery pack, and activates the cooling loop.

In another embodiment, the at least one battery is preheated during charging mode by turning on the heating loop, upon plugging the at least one battery into the at least one battery swapping slot.

In yet another embodiment, the at least one battery is configured to be cooled based on a thermal profile selected to run for the at least one battery, or if the at least one battery is already too hot prior to insertion of the at least one battery into the at least one battery swapping slot.

The swapping controller (126) is configured to maintain temperature of the at least one battery above 25 degrees Celsius during the charging mode of the at least one battery. The swapping controller (126) is further configured to maintain the temperature of the at least one battery below a certain temperature, based on the thermal profile required.

In an embodiment, the swapping controller (126) is further configured to adjust independently battery temperature of each of the plurality of battery swapping slots (102).

In one embodiment, the swapping controller (126) is further configured to actuate the three-way valve (116).

In another embodiment, the swapping controller (126) is further configured to actuate the pump and maintain position of the three-way valve (116).

In yet another embodiment, the swapping controller (126) is, but not restricted to, an Arduino microcontroller board, an 8085 microcontroller, or any other microcontroller.

The cooling reservoir (134) and the heating reservoir (136) are positioned at rear portion of the battery swapping station (200). The cooling reservoir (134) and the heating reservoir (136) are configured to maintain the fluid at fixed setpoint temperatures.

In one embodiment, the cooling reservoir (134) is configured to act as a heat pump for a heating reservoir (136).

In another embodiment, the cooling reservoir (134) and the heating reservoir (136) are configured to modulate temperature of each of the plurality of batteries (104), according to charging profile of each battery in the plurality of batteries (104), to enable fast charging of the plurality of batteries (104).

The charging unit (148) is positioned at the rear portion of the battery swapping station (200). The charging unit (148) is configured to be positioned at bottom with respect to the cooling reservoir (134) and the heating reservoir (136). The charging unit (148) is further configured to boost charging capacity of each of the plurality of batteries (104), by providing electric charge to the plurality of batteries (104).

FIG. 8 illustrates a schematic view of a cooling loop (130) formed in the battery swapping station (100, 200), according to one embodiment of the present invention. FIG. 8 will be explained in conjunction with FIGS. 2 and 7. A cooling loop (130) comprises of at least one base plate (123), a first three-way valve (125), a second three-way valve (127), a first pump (128), a second pump (129), the cooling reservoir (134), the heating reservoir (136), a compressor (150), a chiller (152), a condenser (154), and a receiver dryer (156). The coolant inside the at least one base plate (123) is basically the dielectric coolant or any non-dielectric coolant like water-glycol mixture that extracts heat from the at least one base plate (123), and takes the extracted heat out to the chiller (152), and delivers heat to the battery in the heating loop. The dielectric coolant inside the at least one base plate (123) does not change its phase and remains in a liquid phase. Once the dielectric coolant reaches to the chiller (152) by taking the extracted heat out to the chiller (152), the chiller (152) is configured to then exchange heat with other components within a refrigeration loop or a refrigeration unit (158). The refrigeration unit (158) houses the compressor (150), the chiller (152), the condenser (154), and the receiver dryer (156).

The first three-way valve (125) is the valve corresponding to the cooling reservoir (134) and connected with the at least one base plate (123), and the second three-way valve (127) is the valve corresponding to the heating reservoir (136), and connected with the at least one base plate (123). The first three-way valve (125) and the second three-way valve (127) are configured to be actuated simultaneously upon activation of the cooling loop (130). The first pump (128) and the second pump (129) are the pumps corresponding to the cooling reservoir (134) and the heating reservoir (136) respectively, and are configured to pump the liquid.

In one embodiment, the first pump (128) is positioned between the first three-way valve (125) and the cooling reservoir (134). The first pump (128) is configured to be connected to the first three-way valve (125) and the cooling reservoir (134).

In another embodiment, the second pump (129) is positioned between the second three-way valve (127) and the heating reservoir (136). The second pump (129) is configured to be connected to the second three-way valve (127) and the heating reservoir (136).

The cooling reservoir (134) is basically the reservoir in which the water or glycol solution or any fluid is at a temperature of 20 degrees Celsius or 25 degrees Celsius, which is lower than ambient temperature. The heating reservoir (136) is the reservoir in which the fluid can be maintained at a temperature of 60 degrees Celsius or 70 degrees Celsius or any other temperature higher than minimum ambient temperature or maximum ambient temperature.

The compressor (150) is one of the components housed inside the refrigeration unit (158), and is configured to circulate the fluid or refrigerant under pressure, to concentrate the heat. This concentrated heat is a low-pressure gas converted into a high-pressure gas.

The chiller (152) comprises an interface like the refrigerant which exchanges heat with the water glycol mix in liquid phase, to circulate back the heat to the at least one base plate (123). The chiller (152) is configured to chill or cool down the fluid which is already present in the cooling reservoir (134).

The condenser (154) is configured to heat the oil or the water glycol solution or any fluid solution present in the heating reservoir (136).

The receiver dryer (156) is configured to be housed inside the refrigeration unit (158). The receiver dryer (156) is further configured to be connected with the compressor (150), the chiller (152), and the condenser (154). The receiver dryer (156) is further configured to receive the heat and performing drying operation to dry the heat in form of a gas.

In an embodiment, if the at least one battery comes into contact or engages with the electrical connector (146), and the at least one battery needs to be charged, then all the four base plates (as shown in FIG. 6B) comes together to clamp the at least one battery from all four sides, and one of the loops, either the cooling loop (130) or the heating loop is activated. In one instance, if we want to maintain the temperature of 20 degrees Celsius to the at least one battery, the cooling loop (130) will get started having the first three-way valve (125) open. The second pump (129) connected with the heating reservoir (136) starts pumping the fluid by circulating the fluid in the heating reservoir (136) and the condenser (154) to heat up the at least one battery. During initiation of charging of the at least one battery at a certain point, the at least one battery gets heated at a higher rate.

In one embodiment, there are some algorithms used to maintain temperature of the at least one battery or the plurality of batteries (104) above 60 degrees Celsius to charge them faster, without much degradation. At this point, after some time the second three-way valve (127) is switched in a manner, such that the heating loop starts, and the cooling loop (130) gets closed. Hence, in this way, the heating loop starts heating the at least one base plate (123).

In another embodiment, the refrigeration unit (158) is used to maintain temperature of the cooling reservoir (134) and the heating reservoir (136).

In yet another embodiment, the temperature of the cooling reservoir (134) and the heating reservoir (136) is predefined.

In yet another embodiment, for instance, if there are 99 battery swapping boxes, the in this case there will be ninety nine cooling fluid inlets and ninety nine cooling fluid outlets. The refrigeration unit (158) of the cooling loop (130) as shown in FIG. 8 will be connected in a parallel configuration in a way that the cooling reservoir (134) will have different outlets. The refrigeration unit (158) becomes a common unit for entire battery swapping station (100). Hence, when one battery is being charged in the battery swapping box (base plate), then the pump gets activated to activate one loop (cooling or heating), and when another battery is charged in some other battery swapping box (another base plate), then another loop gets activated (cooling or heating).

FIG. 9 illustrates a schematic view of a heating loop (132) formed in the battery swapping station (100, 200), according to another embodiment of the present invention. The heating loop (132) comprises of the at least one base plate (123), the first three-way valve (125), the second three-way valve (127), the first pump (128), the second pump (129), the cooling reservoir (134), the heating reservoir (136), the compressor (150), the chiller (152), the condenser (154), and the receiver dryer (156). For maintaining the temperature of 60 degrees Celsius for the heating reservoir (136), the first pump (128) at the cooling reservoir (134) is started and arrangement of the first three-way valve (125) is electronically actuated. Upon starting of the first pump (128), the first pump (128) will pump the fluid in the cooling reservoir (134) into the at least one base plate (123) with the first three-way valve (125). The fluid after getting pumped and reaching to the at least one base plate (123) passes through outlet of the at least one base plate (123) and comes back again to the cooling reservoir (134), to maintain temperature below than the ambient temperature.

Various modifications to these embodiments are apparent to those skilled in the art from the description. The principles associated with the various embodiments described herein may be applied to other embodiments. Therefore, the description is not intended to be limited to the embodiments but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

1-21. (canceled)

22. A battery swapping station for use with a battery casing, the station comprising:
a plurality of battery swapping slots;
a plurality of batteries configured to be detachably inserted into the plurality of battery swapping slots; and
a base plate assembly housed inside the plurality of battery swapping slots and connected with the plurality of batteries, characterizing:
a plurality of base plates with each base plate having a heat transfer surface, wherein each of the plurality of base plates is configured to extract heat from the battery casing and heat at least one battery of the plurality of batteries; and
a plurality of thermal pads with each thermal pad configured to cover the heat transfer surface of each base plate of the plurality of base plates,
wherein if the at least one battery of the plurality of batteries is inserted inside the accommodating space, the at least one base plate of the plurality of base plates is configured to be movable in an upward position, until a certain amount of force between the at least one base plate and the at least one battery is achieved, wherein the base plate assembly is configured to be mechanically mounted on a plurality of guide rails, wherein if at least one base plate of the plurality of base plates is movable in a downward position, an accommodating space is created for the at least one battery of the plurality of batteries to slide over the accommodating space without interference, and
wherein the plurality of battery swapping slots, the plurality of batteries, the base plate assembly, the plurality of base plates, the plurality of thermal pads, and the plurality of guide rails are integrated as a single unit to form the battery swapping station.

23. The battery swapping station as claimed in claim 22, wherein if the plurality of base plates is in an engaged position, the plurality of base plates is configured to clamp the at least one battery into at least one battery swapping slot from the plurality of battery swapping slots.

24. The battery swapping station as claimed in claim 23, wherein the plurality of base plates comprises an extra locking system, the extra locking system configured to provide locking via high clamping force leading to a high static friction limit, to prevent extraction of the at least one battery from the at least one battery swapping slot without permission, when the plurality of base plates is in an engaged position.

25. The battery swapping station as claimed in claim 22, further comprising a three-way valve configured to connect each of the plurality of base plates with a cooling loop and a heating loop.

26. The battery swapping station as claimed in claim 25, wherein the three-way valve is configured to be open or closed to either of the cooling loop and the heating loop.

27. The battery swapping station as claimed in claim 22, wherein the at least one base plate of the plurality of base plates is configured to be detachably mounted on at least one rigid bar of the plurality of rigid bars, through a spring.

28. The battery swapping station as claimed in claim 27, wherein the plurality of rigid bars is configured to be movable over the plurality of guide rails, through a plurality of linear bearings.

29. The battery swapping station as claimed in claim 22, further comprising a plurality of electric motors configured to control position of the plurality of base plates.

30. The battery swapping station as claimed in claim 22, wherein each of the plurality of base plates is configured to provide fluid flow channels, the fluid flow channels formed within each of the plurality of base plates.

31. The battery swapping station as claimed in claim 22, further comprising a pump configured to circulate ethylene water-glycol mixture or water or dielectric fluid in the cooling loop and the heating loop.

32. The battery swapping station as claimed in claim 22, wherein the plurality of base plates is made of a material selected from a group of materials of aluminium, copper or any other solid or highly thermal conductive or resistive material.

33. A battery swapping station for use with a battery pack, the station comprising:
a plurality of battery swapping slots;
a plurality of batteries configured to be detachably inserted into the plurality of battery swapping slots;
a sensor housed within at least one battery swapping slot to detect the plurality of batteries;
a swapping controller communicably coupled with the plurality of battery swapping slots, the plurality of batteries, and the sensor, the swapping controller configured to:
enable a plurality of base plates to engage with the battery pack;
switch position of a three-way valve based on engagement of the plurality of base plates with the battery pack; and
activate a cooling loop or a heating loop, based on the switched position of the three-way valve; and
a plurality of motors configured to control position of the plurality of base plates;
wherein if at least one battery detects the at least one battery swapping slot, at least one motor of the plurality of motors is configured to move the plurality of base plates towards the battery pack, and activates the cooling loop, wherein the at least one battery is preheated during charging mode by turning on the heating loop, upon plugging the at least one battery into the at least one battery swapping slot, and wherein the at least one battery is configured to be cooled based on a thermal profile selected to run for the at least one battery, or if the at least one battery is already too hot prior to insertion of the at least one battery into the at least one battery swapping slot.

34. The battery swapping station as claimed in claim 33, wherein the swapping controller is configured to maintain temperature of the at least one battery above 25 degrees Celsius during the charging mode of the at least one battery.

35. The battery swapping station as claimed in claim 33, wherein the swapping controller is further configured to maintain the temperature of the at least one battery below a certain temperature, based on the thermal profile required.

36. The battery swapping station of claim 33, wherein a change in position of the three-way valve is configured to activate the cooling loop or the heating loop.

37. The battery swapping station of claim 33, wherein each of the plurality of battery swapping slots is configured to connect the cooling loop and the heating loop in a parallel configuration.

38. The battery swapping station of claim 33, wherein the swapping controller is configured to adjust independently battery temperature of each of the plurality of battery swapping slots.

39. The battery swapping station of claim 33, wherein each of the plurality of battery swapping slots comprises of a plurality of valves which are configured to be open periodically to control temperature of each of the plurality of batteries.

40. The battery swapping station of claim 33, further comprising a cooling reservoir and a heating reservoir configured to maintain the fluid at fixed setpoint temperatures.

41. The battery swapping station of claim 33, wherein the cooling reservoir is configured to act as a heat pump for a heating reservoir.

42. The battery swapping station of claim 33, wherein the cooling reservoir and the heating reservoir are configured to modulate temperature of each of the plurality of batteries, according to charging profile of each battery in the plurality of batteries, to enable fast charging of the plurality of batteries.
